(19) United States
(12) Patent Application Publication
(10) Pub. No.: US 2007/0278828 A1
(43) Pub. Date: Dec. 6, 2007

(54) Pillar for a Motor Vehicle

(75) Inventors: Michael Anders, Althengstett (DE); Wolfgang Fussnegger, Tuebingen (DE); Konrad Goetz, Karlsruhe (DE); Wolfgang Kleinekathoefer, Waldstetten (DE)

Correspondence Address: CROWELL & MORING LLP;INTELLECTUAL PROPERTY GROUP, P.O. BOX 14300, WASHINGTON, DC, 20044-4300, US

(73) Assignee: DamilerChrysler AG, Stuttgart (DE)

(21) Appl. No.: 10/582,270

(22) PCT Filed: Nov. 10, 2004
(86) PCT No.: PCT/EP04/12686

§ 371 Date: Apr. 6, 2007

(30) Foreign Application Priority Data
Dec. 11, 2003 (DE) 10357927.3

(51) Int. Cl. B62D 25/04

(52) U.S. Cl. 296/193.06

(57) ABSTRACT

An A-pillar for a motor vehicle running from a vehicle roof in the direction of a vehicle floor and having a curved profile over at least one longitudinal section, has an essentially solid circumferential surface and is of essentially hollow configuration in an inner region. The A-pillar in its curved longitudinal section has a reinforcement strut which passes through a hollow cross section of the A-pillar. The reinforcement strut runs from a rear wall region of the A-pillar to a front wall region. The reinforcement strut may have an elliptical or a circular recess along an upper and a lower boundary line. The A-pillar thus achieves high strength at reduced weight.

This application is a national phase application of International application PCT/EP2004/012686 filed Nov. 10, 2004 and claims the priority of German application No. 103 57927.3, filed Dec. 11, 2003, the disclosures of which are expressly incorporated by reference herein.

### BACKGROUND AND SUMMARY OF THE INVENTION

The invention relates to an A-pillar for a motor vehicle.

Under the premise of high body stiffness and body strength increasingly greater demands are made of the vehicle body in terms of lightweight construction. The publications DE 100 15 325 A1 and WO 03 03 12 52 A1 propose body components, in particular A-pillars, which are composed of cast steel and are reinforced by different reinforcements or ribbed structures. Both proposed A-pillars have, however, a multiplicity of struts and ribs which serve for reinforcement purposes. However, in order to optimize the weight of the component, it is necessary to reduce the multiplicity of strut structures while retaining the strength and stiffness of the component. The object of the invention is to provide an A-pillar which has the same strength and stiffness as an A-pillar from the prior art and in this case comprises a lower weight.

The object is achieved in an A-pillar of a motor vehicle which runs from a vehicle roof in the direction of a vehicle floor and in this case has a curved profile at least over one longitudinal section. The A-pillar has an essentially solid circumferential surface, in this case it is of essentially hollow configuration in its inner region.

The A-pillar is distinguished in that, in its curved longitudinal section, it has a reinforcement strut which in turn passes through a hollow cross section of the A-pillar. The reinforcement strut passes through the A-pillar from a rear wall region to a front wall region with respect to the vehicle. In this case, the reinforcement strut is configured in such a manner that it has an elliptical or a circular recess in an upper and lower boundary line—with respect to the motor vehicle. The radius of the ellipse or of the circle can change along the profile of the recess. The recess can thus assume a curved form.

The reinforcement strut passes through the A-pillar in the region of its greatest curvature, to be precise from a rear region to a front region. This means it passes through the A-pillar in the region in which the maximum loading occurs should the vehicle roll over. It is in this loading situation that the maximum forces act right in the curvature of the A-pillar and then act in particular on the front and the rear wall region. In this case, the wall region which is at the front with respect to the vehicle is loaded in tension, with the rear wall region being loaded in compression. The reinforcement strut therefore runs in a specific manner from a region severely loaded in tension to a region severely loaded in compression. Both high loading regions are connected by the reinforcement strut, as a result of which the A-pillar's buckling strength or deflection resistance is improved in a specific manner.

This profile of the reinforcement strut dissipates stresses which would otherwise have to be borne by a wall region of the A-pillar. The wall regions are relieved in turn from load, which leads to the A-pillar having higher strength and at the same time permits a saving on material and therefore a reduction in the weight of the wall regions of the A-pillar.

In addition, the reinforcement strut of the A-pillar is distinguished in that it has an elliptical or circular recess in the upper and lower boundary line. These recesses have the effect that the stiffness of the A-pillar is raised continuously and homogeneously in the region of curvature which is reinforced by the strut. This avoids discontinuities in the stiffness. Discontinuities in the stiffness would lead, in the event of dynamic loading, to notch stresses in the reinforcement strut, which in turn could lead to the strut fracturing and to a sudden loss in stiffness and strength of the A-pillar. The recesses in the reinforcement strut are therefore optimized to the occurrence of sudden high dynamic stresses which occur in the case of the vehicle rolling over.

The height of the reinforcement strut, in each case as measured from its deepest recess, is advantageously at least 5 centimeters. The reinforcement strut generally has a maximum height in this case of 30 centimeters. In special loading situations, a higher height may also be expedient.

In a refinement of the invention, the A-pillar and the reinforcement strut are configured by an integrated cast steel component. In this case, the reinforcement strut is particularly firmly connected to the A-pillar, which is beneficial for the stiffness. In addition, a plurality of joining steps can be saved by the production of an integral component, thus reducing the production costs.

In particular by means of production in a casting process, it is possible to configure the wall regions of the A-pillar and of the reinforcement strut with a variable wall thickness. This enables the special loading situations to be entered into in a specific manner and therefore enables material to be reduced at locations subjected to less loading, which in turn benefits the weight of the component.

In an advantageous refinement, the A-pillar runs in turn from a wall region of increased wall thickness to another wall region of increased wall thickness. These wall regions are in turn the wall regions which are subject in each case to the greatest tensile and compressive stress. As already explained, these wall regions are front and rear wall regions with respect to a vehicle. Accordingly, these wall regions, the front and rear wall regions, are therefore configured with an increased wall thickness. By contrast, lateral wall regions of the A-pillar can be produced in an appropriately thin manner.

The strut which passes through the A-pillar brings about a significant reduction in the number of further struts with which an A-pillar is usually provided. In a refinement of the invention, depending on the loading situation, the entire A-pillar can just be provided with a single reinforcement strut.

Other objects, advantages and novel features of the present invention will become apparent from the following detailed description of the invention when considered in conjunction with the accompanying drawings for example.

### BRIEF DESCRIPTION OF THE DRAWINGS

FIG. 1 shows a longitudinal section through a motor vehicle with an A-pillar and reinforcement strut in accordance with an embodiment of the present invention,

FIG. 2a shows a longitudinal section through an A-pillar with a reinforcement strut in accordance with an embodiment of the present invention,

FIG. 2b shows a cross section through the A-pillar from FIG. 2a along the section IIb,

FIG. 2c shows a cross section through an A-pillar according to FIG. 2a along the section IIc,

FIG. 3a shows a longitudinal section through an A-pillar with a reinforcement strut in accordance with another embodiment of the present invention, which has a variable cross section,

FIGS. 3b, c show examples of a cross section of a reinforcement strut through the section IIIb, IIIc from FIG. 3a,

FIG. 4 shows a cross section through an A-pillar in accordance with another embodiment of the present invention, depicting the forces acting on the A-pillar,

FIGS. 5a, show various types of A-pillars and their b, c orientation with respect to the side edge and the sill region.

### DETAILED DESCRIPTION

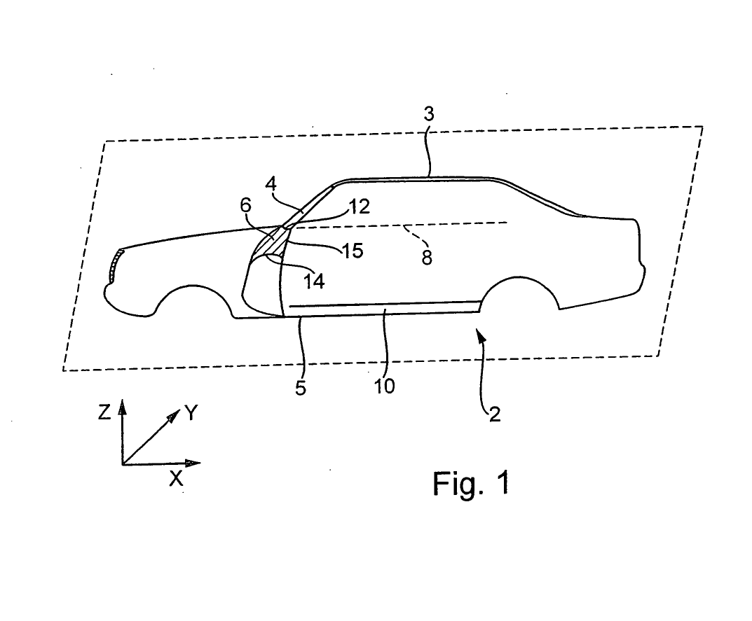

FIG. 1 illustrates a basic arrangement of the claimed A-pillar in a typical vehicle. The motor vehicle 2, which is sectioned in FIG. 1 by its longitudinal center plane which, in turn, lies in the plane of projection, has a side edge 8, a sill 10 and a vehicle roof 3 and a vehicle floor 5. The A-pillar therefore runs from a vehicle roof 3 in the direction of a vehicle floor 5 and, in this example, ends with the sill 10. It has an essentially solid circumferential surface 17. For all of the further figures, a system of coordinates defined by FIG. 1 is applied for the purpose of better representation. According to the system of coordinates illustrated in FIG. 1, the transverse plane of the vehicle, in this case the plane of projection, is referred to as the XZ plane. According to this definition, the Y-axis points into the plane of projection, with the XY plane approximately corresponding to the carriageway.

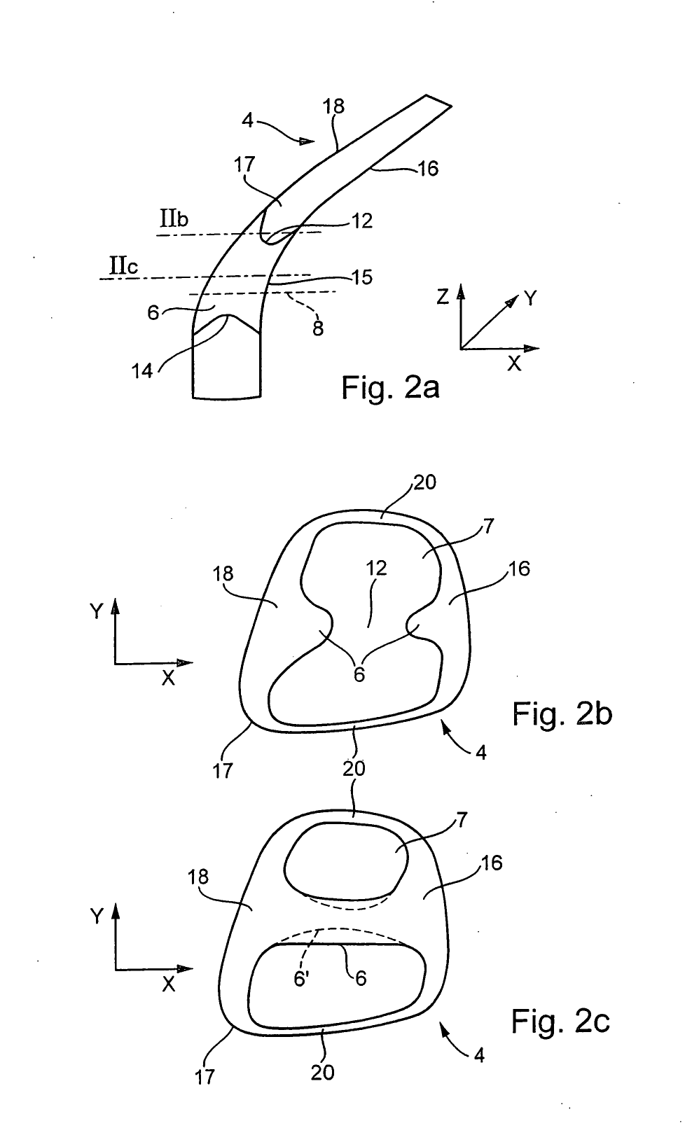

Analogously to FIG. 1, FIG. 2a illustrates an A-pillar 4 without the vehicle. FIG. 2a is a sectional drawing through the A-pillar 4. It should be noted here that, in the section, the A-pillar is not entirely situated in the XZ plane; depending on the type of vehicle, the profile of the A-pillar also has a curvature in the Y-direction. The section of the A-pillar through the XZ plane, as illustrated in FIG. 2a, therefore merely constitutes a graphical simplification.

It should be pointed out at this point that the term A-pillar very generally comprises various regions of extension of this pillar. This may be defined by FIGS. 5a to c. FIG. 5a illustrates an A-pillar 4 which reaches from a vehicle roof (not illustrated here) as far as a side edge 8 (illustrated by a dashed line). The A-pillar 4 from FIG. 5b reaches from a vehicle roof beyond the side edge 8 and is connected there to the rest of the vehicle body by a connection (not illustrated). The term A-pillar can also be understood as meaning an A-pillar 4 according to FIG. 5c extending from a vehicle roof beyond the side edge 8 to the vehicle floor 5 or to the sill 10.

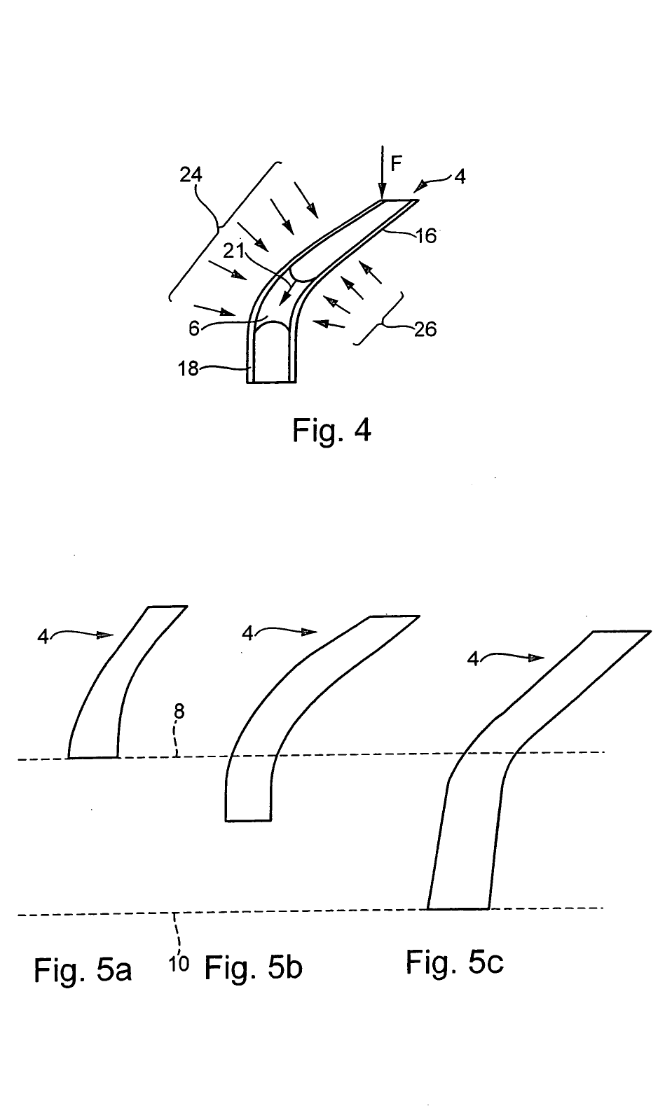

The A-pillar 4 from FIG. 2a has a reinforcement strut 6 which is arranged in the region of a curvature 15 of the A-pillar 4. The region of greatest curvature 15 frequently runs in the region of the side edge 8 or somewhat above it. In this case, as illustrated in the sections 2b and 2c, the reinforcement strut structure 6 runs approximately in the X-direction, with the precise profile of the reinforcement strut 6 being adapted with respect to the stress profile indicated in FIG. 4 by the loading situation F of the vehicle rolling over.

The reinforcement strut 6 essentially runs from a rear region 16 of the A-pillar with respect to the direction of travel (X direction) to a front region 18 of the A-pillar 4 with respect to the direction of travel. These wall regions 16, 18, on which also the greatest tensile stress and compressive stress act, also have the greatest wall thickness of the A-pillar 4. In contrast to this, the outer or lateral wall regions 20 are configured to be relatively thin in the Y-direction. If appropriate, the wall regions 20 can even be of such thin configuration that the A-pillar no longer contains any material at all in this region, and accordingly is of open design.

A reinforcement strut 6 is illustrated, and with a dashed line 6′, in the YX cross section of FIG. 2c (hollow cross section 7), with it being possible for the cross section of the reinforcement strut 6, 6′ to taper or be thickened in accordance with the forces which occur and with respect to its Z-extent. The wall thickness of the reinforcement strut 6 or 6′ is expediently, for casting reasons, tapered in a central region (see line 6′) with respect to the YX plane along its longitudinal extent. This tapering 6′ leads to fewer stresses occurring during the casting of the A-pillar and during the cooling of the cast part.

FIG. 2b illustrates the hollow cross section 7 along the YX plane IIb from FIG. 2a. The cross section IIb runs through the region of a recess 12 of the reinforcement strut 6 from FIG. 2a. In FIG. 2b, greater wall thicknesses can in turn be seen in the region 18 and 20, i.e. in the regions of high tensile and compressive stress. The lugs of the reinforcement struts 6 are already present but are interrupted by the recess 12.

Should these recesses 12 and 14 not be inserted, in a loading situation according to FIG. 4, which is characterized by the force F and is intended to simulate a vehicle rolling over, stress peaks 21 would occur which could lead to the reinforcement strut 6 fracturing. The recesses 12 and 14 minimize the stress peaks 21. In FIG. 4, the tensile stresses 24 which occur in the loading situation and act on a front side of the A-pillar and compressive stresses 26 on a rear side of the A-pillar are furthermore illustrated diagrammatically. In principle, it is expedient for the entire profile of the A-pillar to have a higher wall thickness in the region of the tensile stresses 24 and the compressive stresses 26.

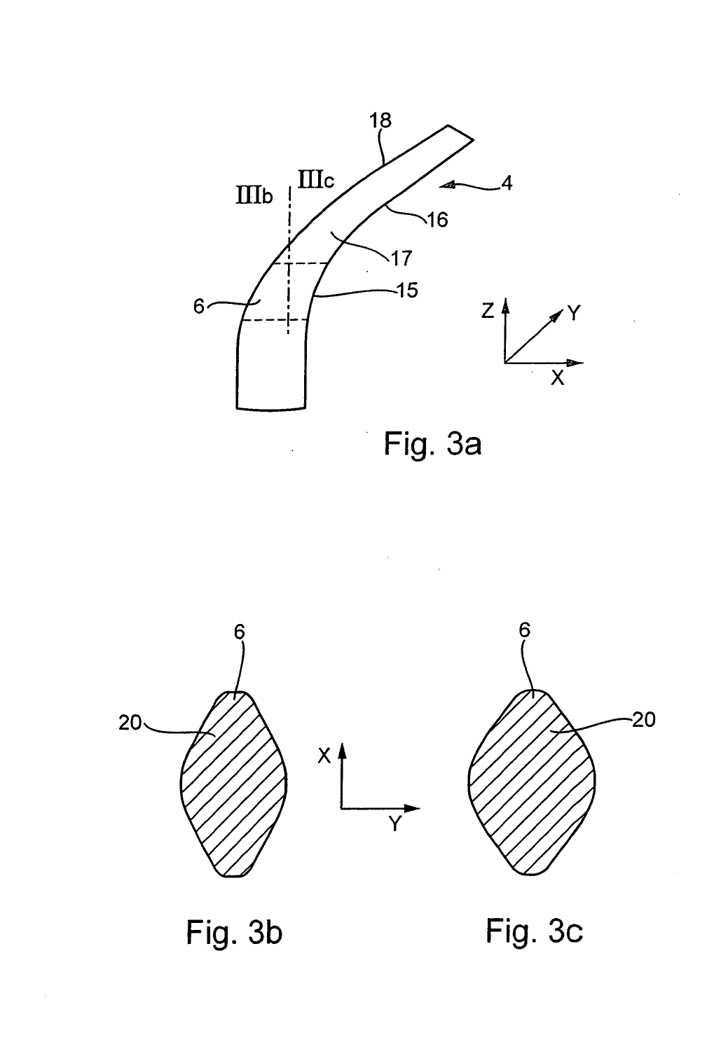

An alternative possibility for minimizing stress peaks is, analogously to FIG. 3, to design the reinforcement strut 6 to be thinner in an upper region and to let it become thicker in a central region and to be thinned again in a lower region. FIG. 3a illustrates an A-pillar of this type which essentially corresponds to the one in FIG. 2a but does not have any recesses 12 and 14 which are present there. Instead, an A-pillar 4 of this type varying wall thickness along the section 3b, 3c which is situated in the YX plane. Examples of possible varying wall thicknesses are illustrated in FIGS. 3b and 3c. Reinforcement struts 6 of this type each have their greatest thickness in the center. How they taper upward and downward depends on the load situation existing in each case. Of course, reinforcement struts 6 of this type according to FIG. 3 may also be provided with recesses (not illustrated here) in the upper and lower region.

The foregoing disclosures has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-7. (canceled)

8. An A-pillar for a motor vehicle, comprising:
a hollow pillar having a curved profile between an roof end and a floor end over at least one longitudinal section therebetween, and an essentially solid circumferential surface; and
a reinforcement strut,
wherein the reinforcement strut
passes through a hollow cross section region in the curved longitudinal section of the pillar,
extends between a rear wall region of the pillar and a front wall region of the pillar, and
has an elliptical or a circular recesses in upper and lower surfaces.

9. The A-pillar as claimed in claim 8, wherein the reinforcement strut has a height of at least 5 cm, as measured between mutually closest points on the upper and lower recesses.

10. The A-pillar as claimed in claim 8, wherein the reinforcement strut is a cast steel component.

11. The A-pillar as claimed in claim 9, wherein the reinforcement strut is a cast steel component.

12. The A-pillar as claimed in claim 8, wherein the wall regions of the A-pillar are configured with variable wall thicknesses.

13. The A-pillar as claimed in claim 12, wherein the reinforcement strut runs between a first wall region of increased wall thickness and a second wall region of increased wall thickness.

14. The A-pillar as claimed in claim 13, wherein the pillar has an increased wall thickness in a front wall region and a rear wall region.

15. The A-pillar as claimed in claim 8, wherein the pillar has only one reinforcement strut.
